(19) United States
(12) Patent Application Publication
(10) Pub. No.: US 2006/0218340 A1
(43) Pub. Date: Sep. 28, 2006

(54) Data validity determining method for flash EEPROM and electronic control system

(75) Inventors: Yoichi Fujita, Toyoake-city (JP); Kyouichi Suzuki, Toyohashi-city (JP); Chihiro Tomimatsu, Hazu-gun (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/384,822

(22) Filed: Mar. 21, 2006

(30) Foreign Application Priority Data
Mar. 22, 2005 (JP) 2005-82451

(51) Int. Cl. G06F 12/00

(52) U.S. Cl. 711/103

(57) ABSTRACT

In an electronic control system, it is determined whether leading end identification information in a data verification space of a flash EEPROM of an electronic control unit is an expected value. When it is yes, it is then determined whether terminal identification information in the data verification space is the expected value. Then, when it is yes, it is determined whether the leading end identification information and the trailing end identification information are identical to each other. When it is yes, it is determined that data between the leading end identification information and the trailing end identification information is valid. Otherwise, it is determined that the data is invalid.

### CROSS REFERENCE TO RELATED APPLICATION

This application is based on and incorporates herein by reference Japanese Patent Application No. 2005-82451 filed on Mar. 22, 2005.

### BACKGROUND OF THE INVENTION

1. Field of the Invention

The present invention relates to a data validity determining method for a flash electrically erasable and programmable read-only memory (EEPROM) and an electronic control system.

2. Description of Related Art

An electronic control system of, for example, a vehicle includes a plurality of electronic control units for controlling subject devices (or systems), such as an internal combustion engine, a transmission, a brake system. In some electronic control units, a corresponding control program (specifically, for example, instruction codes of the control program, specific control data referred by the control program) for controlling the subject device is stored in an electrically rewritable flash EEPROM. Even after release of such an electronic control unit in the market, the control program of the flash EEPROM can be rewritten on-board (i.e., in a state where the electronic control unit is kept installed in, for example, the vehicle) to upgrade a version of the control program. The electronic control unit of this type is disclosed in, for example, Japanese Unexamined Patent Publication No. H11-141394, Japanese Unexamined Patent Publication No. H11-175331 and Japanese Unexamined Patent Publication No. 2001-265601.

In a normal control mode, the electronic control unit of the above type, which implements the rewriting function for rewriting the control program, controls the subject device, such as the engine, by running the control program stored in the flash EEPROM. When it is determined that a rewriting condition is satisfied by, for example, receiving a rewriting request signal from a flash EEPROM rewriting device (an external device), an operational mode of the electronic control unit is changed from the normal control mode to a flash 10. EEPROM rewriting mode, and thereby the control program in the flash EEPROM is rewritten to a new control program transmitted from the flash EEPROM rewriting device. In this electronic control unit, when the operation (control) of the subject device needs to be changed due to some reasons, the control program can be easily changed. For example, a version of the control program may be upgraded.

However, in the flash EEPROM, at the time of rewriting the data, data in one block is collectively erased, and thereafter, new data is sequentially rewritten in the block. That is, the rewriting of the data involves two processes, i.e., a collective erasing process for collectively erasing the data in the block and a sequentially writing process for sequentially writing the new data in the block. Thus, when the rewriting is interrupted due to some reasons in the middle of the collective erasing process or in the middle of the sequential writing process, the data in the block of the flash EEPROM may possibly become erroneous.

In view of the above point, for example, Japanese Unexamined Patent Publication No. 2002-334024 discloses an electronic control unit, which intends to improve sensing accuracy for sensing data abnormality through a first stage determination, which uses a checksum of data in a flash EEPROM, and a second stage determination, which checks consistency between the data in the flash EEPROM and data in another other memory.

Furthermore, although not specific to the technique of the electronic control unit, Japanese Unexamined Patent Publication No. 2001-307498 discloses a technique for determining consistency between the data stored in one of two flash EEPROMs and the data stored in the other one of the two flash EEPROMs and thereby determining normality of the flash EEPROMs. Furthermore, Japanese Unexamined Patent Publication No. 2003-150458 discloses a technique for sensing a trouble of a flash EEPROM through use of a plurality of check areas in a block (sector) of the flash EEPROM.

At the time of rewriting the control program, when a communication protocol used by the electronic control unit does not coincide with a communication protocol used by the flash EEPROM rewriting device, communication cannot be established between the electronic control unit and the flash EEPROM rewriting device. Thus, it is required to enable checking of the communication protocol by the electronic control unit. However, the communication protocol may change depending on a selected combination between the electronic control unit and the flash EEPROM rewriting device. Thus, in the previously proposed electronic control unit, required communication control information (e.g., an electronic control unit name and a communication protocol) is stored in the flash EEPROM in advance, and the communication control information is retrieved by the electronic control unit to establish the communication with the flash EEPROM rewriting device. In this way, the electronic control unit may deal with various communication protocols.

In the previously proposed electronic control unit, the control program is stored over the multiple blocks of the flash EEPROM, so that rewriting of data of the control program in each block is executed block by block. Thus, in a case where although the collective erasing or sequential writing of data in some of or all of the blocks is interrupted due to some reasons, the rewriting operation of the entire control program is finished, the rewritten control program of the flash EEPROM may possibly become erroneous.

Particularly, in the previously proposed electronic control unit, the communication control information (e.g., the electronic control unit name and the communication protocol) required to communicate with the flash EEPROM rewriting device is stored in advance in the flash EEPROM. Then, this communication control information is retrieved by the electronic control unit by itself to establish the communication with the flash EEPROM rewriting device. Thus, when the interruption occurs in the middle of the rewriting process in the storage area where the communication control information is stored, discrepancy may occur between the communication control information (e.g., the electronic control unit name and the communication protocol) retrieved from the flash EEPROM and the communication control information (e.g., the electronic control unit name and the communication protocol) handled by the flash EEPROM rewriting device. Thus, communication cannot be established between the electronic control unit and the flash EEPROM rewriting device, and therefore the control program rewriting process cannot be effectively finished.

Furthermore, in the previously proposed electronic control unit, it is not possible to determine validity of data stored in a specific storage space (hereinafter, referred to as data verification space) in the flash EEPROM since there is no mechanism for determining the validity of the data in the data verification space in the flash EEPROM. Thus, at the time of determining the validity of the data in the data verification space, it is required to determine validity of the entire data stored in the whole flash EEPROM.

Furthermore, in the previously proposed electronic control unit, as discussed above, there is no mechanism for determining the validity of the data in the specific storage space of the flash EEPROM. Therefore, even when a portion of the control program stored in the flash EEPROM needs to be modified, the entire control program stored in the flash EEPROM should be rewritten. In such a case, the control program rewriting process could take a long time depending on a line speed of the communication line that connects between the electronic control unit and the flash EEPROM, and the rewriting operation of the control program becomes tedious and time consuming.

### SUMMARY OF THE INVENTION

The present invention addresses at least one of the above disadvantages. Thus, according to one aspect of the present invention, there is provided a data validity determining method for a flash EEPROM. According to the method, data is stored in a data verification space of the flash EEPROM in such a manner that the data is stored in a data space of the data verification space, which is interposed between a leading end location and a trailing end location in the data verification space, and each of the leading end location and the trailing end location of the data verification space stores its corresponding predetermined identification information having corresponding predetermined identification data. Then, it is verified whether each of the predetermined identification information in the leading end location and the predetermined identification information in the trailing end location contains the corresponding predetermined identification data. Thereafter, it is determined that the data in the data space is valid when it is verified that each of the predetermined identification information in the leading end location and the predetermined identification information in the trailing end location contains the corresponding predetermined identification data.

According to another aspect of the present invention, there is also provided an electronic control system for controlling a plurality of subject devices. The electronic control system includes a plurality of electronic control units, which are interconnected by a communication line. Each electronic control unit includes a flash EEPROM, which stores a corresponding control program for controlling a corresponding one of the plurality of subject device. The flash EEPROM of at least one of the plurality of electronic control units has a data verification space. The data verification space includes leading end identification information stored in a leading end location, trailing end identification information stored in a trailing end location, and intervening data that is placed between the leading end identification information and the trailing end identification information. Each of the leading end identification information and the trailing end identification information includes its corresponding predetermined identification data.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram showing a structure of an electronic control unit, to which a data validity determining method of a flash EEPROM is applied according to a first embodiment of the present invention;

FIG. 2 is a memory map of a data verification space, to which the data validity determining method of the flash EEPROM is applied according to the first embodiment;

FIG. 3 is a flowchart showing a procedure of the data validity determining method of the flash EEPROM according to the first embodiment;

FIG. 4 is a flowchart showing an exemplary application of the data validity determining method of the flash EEPROM according to the first embodiment; and

FIG. 5 is a memory map of a flash EEPROM, to which a data validity determining method of a flash EEPROM is applied according to a second embodiment of the present invention.

### DETAILED DESCRIPTION OF THE INVENTION

Embodiments of the present invention will be described with reference to the accompanying drawings.

### First Embodiment

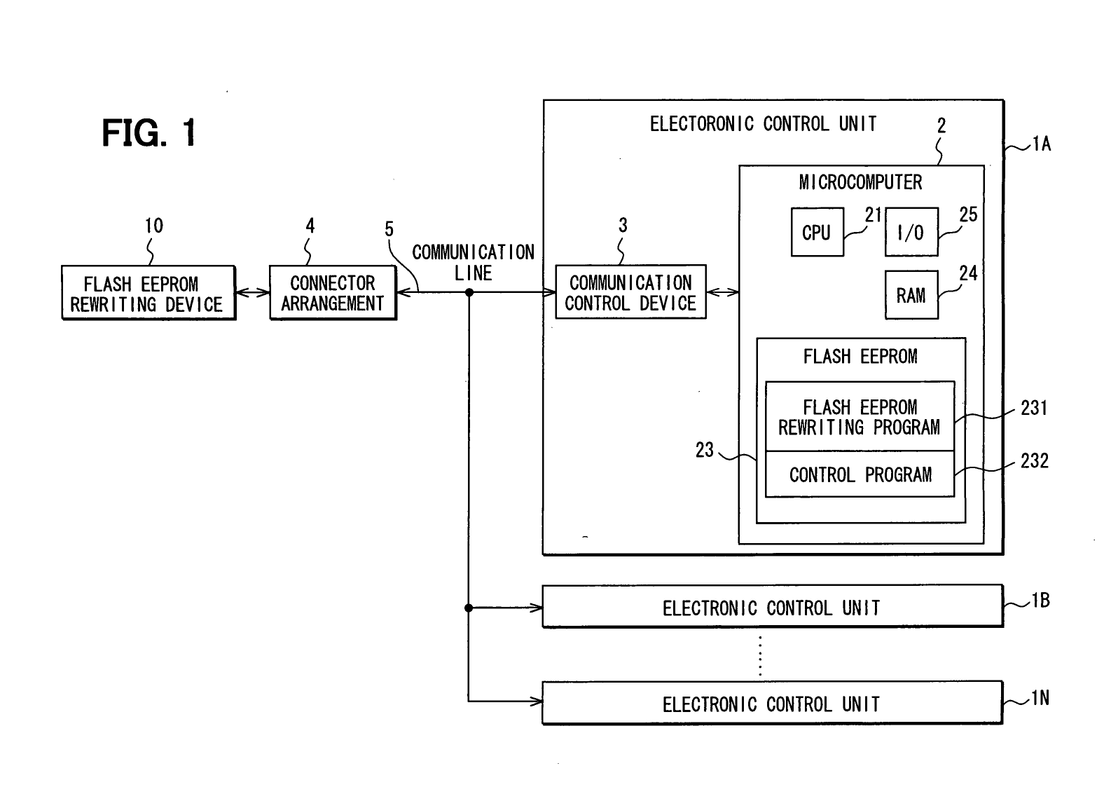

FIG. 1 is a block diagram showing a structure of an electronic control system according to a first embodiment of the present invention. The electronic control system includes a plurality of electronic control units 1A, 1B, . . . , 1N. These electronic control units include, for example, an engine electronic control unit, a body electronic control unit, a brake electronic control unit, a traction electronic control unit and a constant speed travel electronic control unit. The engine electronic control unit is for controlling, for example, fuel injection of an internal combustion engine of a vehicle. The body electronic control unit is for controlling, for example, opening, closing and locking of doors of the vehicle. The brake electronic control unit is for limiting locking of wheels of the vehicle at the time of braking. The traction electronic control unit is for limiting spinning of the wheels in the middle of acceleration of the vehicle speed. The constant speed travel electronic control unit is for driving the vehicle at a constant travel speed.

The electronic control units 1A, 1B, . . . , 1N are interconnected through a communication line 5. The communication line 5 includes an in-vehicle local area network (LAN). More specifically, the communication line 5 may possibly include a car area network (CAN), Safe-by-Wire, FlexRay or the like. A connector arrangement 4 is provided to the communication line 5. A flash EEPROM rewriting device (an external device) 10 is detachably connected to a connector of the connector arrangement 4.

The electronic control unit 1A includes a microcomputer 2 and a communication control device 3. The microcomputer 2 performs various processes for controlling a corresponding subject device (e.g., the engine), which is controlled by the electronic control unit 1A. The communication control device 3 performs data communication with the flash EEPROM rewriting device 10. It should be understood that each of the other electronic control units 1B, . . . , 1N has a structure similar to that of the electronic control unit 1A.

The microcomputer 2 includes a central processing unit (CPU) 21, a flash EEPROM 23, a random access memory (RAM) 24, an input/output (I/O) interface 25 and various registers (not shown). The CPU 21 runs, i.e., executes various programs. The flash EEPROM 23 stores the programs executed by the CPU 21. The RAM 24 temporarily stores results of the computations executed in the CPU 21. The I/O interface 25 communicates signals and data among an input circuit (not shown), an output circuit (not shown) and the communication control device 3.

The flash EEPROM 23 is an EEPROM, on which data may be electrically erased and written in blocks (e.g., block by block or whole blocks at once). The flash EEPROM 23 stores a dedicated flash EEPROM rewriting program 231 and a control program 232. The control program 232 is for controlling the corresponding subject device. Here, although the dedicated flash EEPROM rewriting program 231 is stored in the flash EEPROM 23 in FIG. 1, the dedicated flash EEPROM rewriting program 231 may be alternatively stored in a masked ROM (not shown) of the electronic control unit, which is non-rewritable.

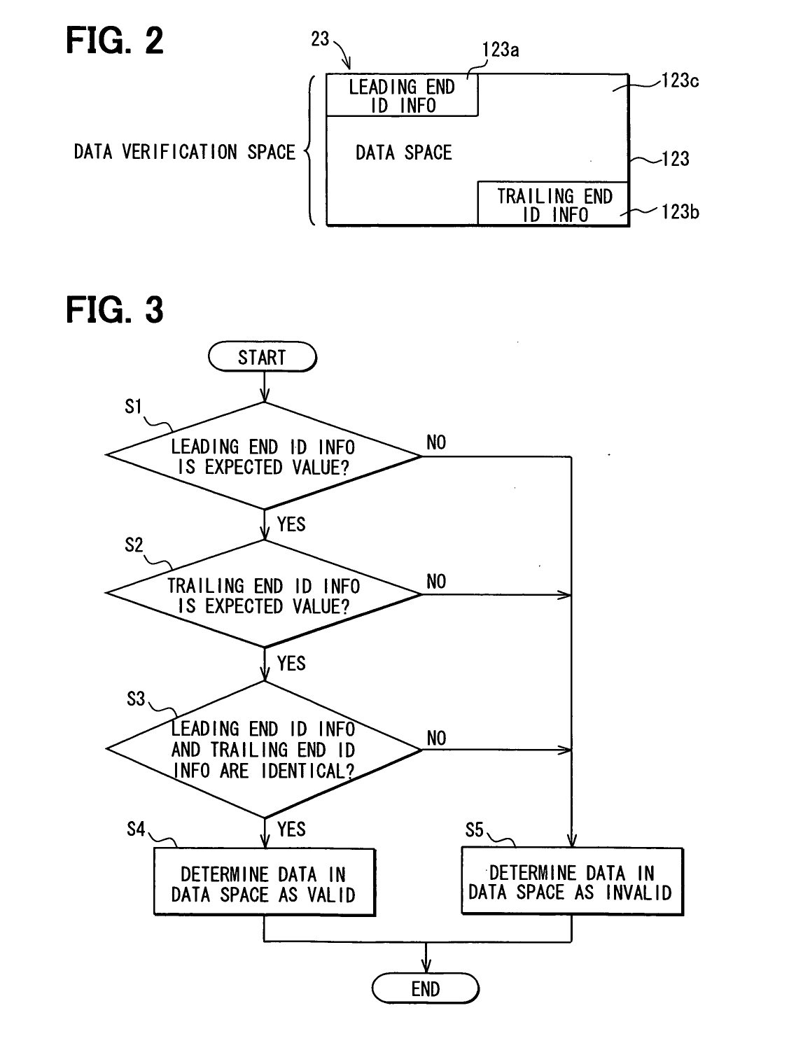

FIG. 2 shows an exemplary data verification space 123 of the flash EEPROM 23 for determining the validity of its stored data. The data verification space 123 includes a leading end location 123a, a trailing end location 123b and a data space 123c. The data space 123c is located between the leading end location 123a and the trailing end location 123b. A position and a size of the leading end location 123a and a position and a size of the trailing end location 123b may vary or may not vary in the data verification space 123. For example, in some cases, the leading end location 123a may be added to a leading end of data stored in the data space 123c, and the trailing end location 123b may be added to a trailing end of the data stored in the data space 123c, so that an entire size of the data verification space 123 may vary depending on the size of the data in the data space 123c. Alternatively, the leading end location 123a may be fixed to a leading end of the data verification space 123, and the trailing end location 123b may be fixed to a trailing end of the data verification space 123. Leading end identification information (leading end ID info) is stored in the leading end location 123a of the data verification space 123, and trailing end identification information (trailing end ID info) is stored in the trailing end location 123b of the data verification space 123. Each of the leading end identification information and the trailing end identification information contains corresponding predetermined data (predetermined identification data). The data space 123c stores the data (also referred to as intervening data), which serves as a verification subject to be verified. In the first embodiment, the data of the data space 123c includes communication control information, such as an electronic control unit name and a communication protocol. A size of the data verification space 123 is not necessarily a size of a block of the flash EEPROM 23. Each of the leading end location 123a and the trailing end location 123b of the data verification space 123 of the flash EEPROM 23 stores its corresponding identification information having the corresponding predetermined data due to the following reason. That is, for example, when it is confirmed that the leading end identification information at the leading end location 123a and the trailing end identification information at the trailing end location 123b coincide with each other and match with an expected value, it can be presumed that the data (particularly, the communication control information, such as the electronic control unit name and the communication protocol) in the data space between the leading end identification information and the trailing end identification information is correctly written, i.e., stored.

Here, the leading end identification information and the trailing end identification information may be set to have identical predetermined data as its corresponding predetermined data described above. For example, the predetermined data of the leading end identification information may be set to 1010 of 4-bit data, and the predetermined data of the trailing end identification information may be also set to 1010 of 4-bit data. In such a case, when it is verified that the leading end identification information (specifically, the predetermined data of the leading end identification information) coincides with the trailing end identification information (specifically, the predetermined data of the trailing end identification information), it may be determined that the data in the data space is valid.

Alternatively, the predetermined data of the trailing end identification information may be set to be different from that of the leading end identification information. For example, the predetermined data of the trailing end identification information may be set to 0101, which is a pattern that is reversed with respect to that of the leading end identification information, which is set to 1010. In this case, when it is verified that the trailing end identification information is the reverse pattern of the leading end identification information, it may be determined that the data in the data space is valid. That is, it is only required to verify that each identification information has the corresponding predetermined data. However, when all data are erased, all data become 1111. Thus, in the case of checking the coincidence between the leading end identification information and the trailing end identification information, an erroneous determination may possibly be made in some cases. Therefore, this may not be desirable data to be used in some cases. It should be noted that the above description about the predetermined data of each identification information is equally applicable to a second embodiment and modifications described below. Furthermore, in the following description, for the sake of simplicity, there is only described the case where the predetermined data of the leading end identification information stored in the leading end location 123a and the predetermined data of the trailing end identification information stored in the trailing end location 123b are identical to each other.

When the control program 232 stored in the flash EEPROM 23 needs to be replaced with a new control program, the flash EEPROM rewriting device 10 is connected to the electronic control unit 1A through the connector arrangement 4 and the communication line 5. This may be performed in, for example, an automobile service station, an automobile dealer, or the like. The connection between the electronic control unit 1A and the flash EEPROM rewriting device 10 is established to allow signal transmission between the electronic control unit 1A and the flash EEPROM rewriting device 10 through connectors (the connectors constituting the connector arrangement 4) of the electronic control unit 1A (or of the electronic control system) and of the flash EEPROM rewriting device 10 via the communication line 5. Specifically, when the connector of the electronic control unit 1A and the connector of the flash EEPROM rewriting device 10 are connected to each other to form the connector arrangement 4, the microcomputer 2 of the electronic control unit 1A can establish serial data communication with the flash EEPROM rewriting device 10 through the communication line 5 and the communication control device 3.

The flash EEPROM rewriting device 10 is the external device, which is external to the electronic control system and has a microcomputer, a control program storage medium, a display and an operational switch arrangement (e.g., a keyboard), all of which are not depicted in the drawings for the sake of simplicity. The display is used to display, for example, various operational menus and error messages. The operational switch arrangement is used to input commands for rewriting data of the flash EEPROM 23 of, for example, the electronic control unit 1A.

The flash EEPROM rewriting device 10 and the electronic control unit 1A (the microcomputer 2) communicate with each other to rewrite the control program 232 of the flash EEPROM 23 in the microcomputer 2. Due to the connection of the multiple electronic control units 1A, 1B, . . . , 1N to the communication line 5, the communication control information (e.g., the name of the corresponding electronic control unit 1A, 1B, . . . , 1N and the communication protocol) is provided in the respective flash EEPROM 23, and thereby the rewriting of the control program 232 is implemented through use of the communication control information.

FIG. 3 is a flowchart showing a procedure of a data validity determining method of the flash EEPROM according to the first embodiment. At the time of determining the validity of the data stored in the data verification space 123 of the flash EEPROM 23, the leading end identification information stored in the leading end location 123a of the data verification space 123 is retrieved first, and it is determined whether the retrieved leading end identification information is the expected value, i.e., matches with the expected value (step S1). When it is determined that the leading end identification information matches with the expected value at step S1, the trailing end identification information stored in the trailing end location 123b of the data verification space 123 is retrieved, and it is determined whether the trailing end identification information matches with the expected value (step S2). When it is determined that the trailing end identification information matches with the expected value at step S2, it is then determined whether the leading end identification information is the same as the trailing end identification information (step S3). When it is determined that the leading end identification information is the same as the trailing end identification information at step S3, it is then determined that the data in the data space, which is interposed between the leading end identification information and the trailing end identification information, is valid (step S4). Other than that, it is determined that the data in the subject data space is invalid (step S5).

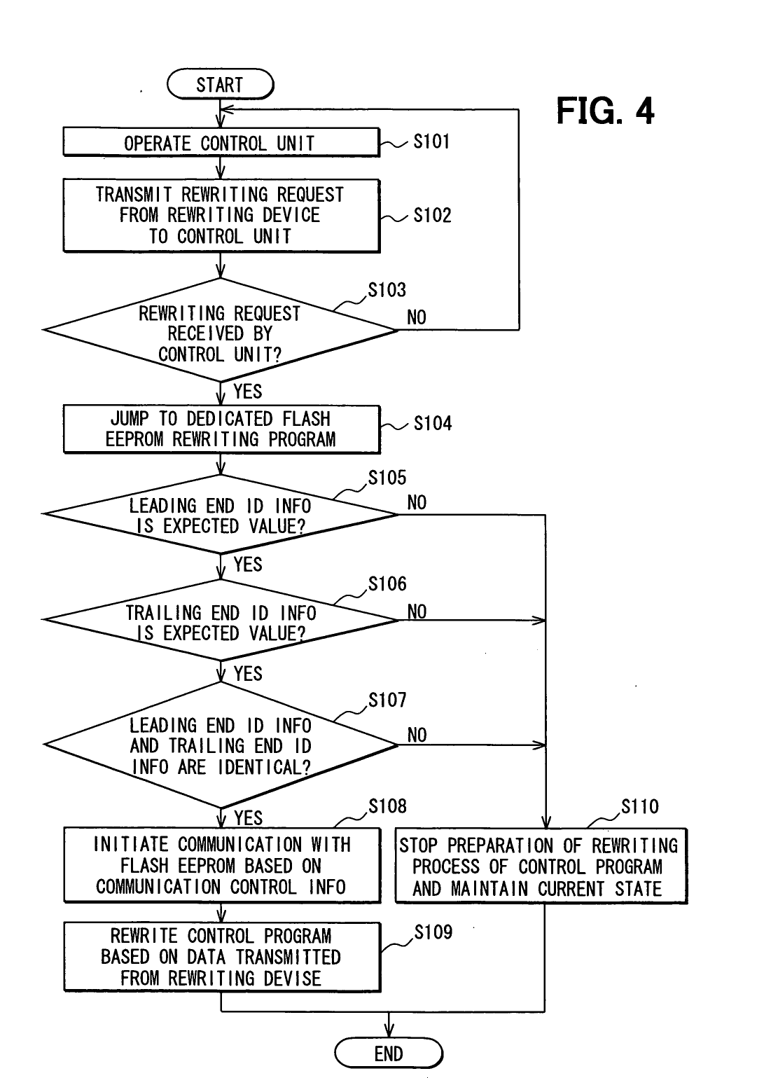

FIG. 4 shows a flowchart showing an exemplary case where the data validity determining method of the flash EEPROM according to the first embodiment is applied to a rewriting process of the control program 232 of the electronic control unit 1A. Specifically, in this flowchart, the communication control information (e.g., the electronic control unit name and the communication protocol) is stored in the data space 123c between the leading end identification information and the trailing end identification information, which are identical to each other, in the data verification space 123 of the flash EEPROM 23 (it is no matter whether the above respective information is stored in blocks or not). Then, the electronic control unit 1A verifies whether the communication control information (e.g., the electronic control unit name and the communication protocol) is valid through use of the data validity determining method of the flash EEPROM of the first embodiment, and thereafter the rewriting process of the control program 232 is initiated upon verifying of the validity of the communication control information.

Next, operation of the electronic control unit 1A, in which the data validity determining method of the flash EEPROM of the first embodiment is applied, will be described in detail. Here, the following description is made with reference to the flowchart of FIG. 4.

When a reset signal from a power supply circuit (not shown) to the microcomputer 2 in the electronic control unit 1A is deactivated upon, for example, turning on of an ignition switch of the vehicle, the CPU 21 initiates execution of the control program 232 stored in the flash EEPROM 23.

Then, the CPU 21 runs the control program 232 to perform an initialization process and then to perform a control process for controlling the subject device in a normal control mode (step S101). Thus, unless a control program rewriting request for requesting rewriting of the control program 232 is transmitted from the flash EEPROM rewriting device 10 to the electronic control unit 1A, the CPU 21 continues to execute the control process for controlling the subject device under the normal control mode.

During the operation of the electronic control unit 1A under the normal control mode, the flash EEPROM rewriting device 10 transmits the control program rewriting request to the electronic control unit 1A through the communication line 5 to rewrite the control program 232 of the electronic control unit 1A (step S102).

Then, in the electronic control unit 1A, the CPU 21 determines whether the control program rewriting request, which is addressed to its own electronic control unit 1A, is received by running the control program 232 (step S103).

When the CPU 21 determines that the control program rewriting request, which is addressed to its own electronic control unit 1A, is not received at step S103 (NO at step S103), control returns to step S01.

When the CPU 21 determines that the control program rewriting request, which is addressed to its own electronic control unit 1A, is received at step S103 (YES at step S103), control jumps from the control program 232 to the dedicated flash EEPROM rewriting program 231 (step S104), so that the operation is shifted from the normal control mode to a flash EEPROM rewriting mode.

When the operation is shifted to the flash EEPROM rewriting mode, the CPU 21 runs the dedicated flash EEPROM rewriting program 231 to determine whether the leading end identification information stored in the leading end location 123a of the data verification space 123 of the flash EEPROM 23, to which the rewriting request is addressed, is the expected value as a step for preparing the rewriting process of the control program 232 of the flash EEPROM 23 (step S105).

When it is determined that the leading end identification information does not match with the expected value at step S105 (NO at step S105), the CPU 21 determines that the data in the data space 123c of the data verification space 123 of the flash EEPROM 23 is not the communication control information (e.g., the electronic control unit name and the communication protocol) of the intended verification subject by running the dedicated flash EEPROM rewriting program 231. Then, control proceeds to step S110.

In contrast, when it is determined that the leading end identification information matches with the expected value at step S105 (YES at step S105), the CPU 21 determines whether the trailing end identification information stored in the trailing end location 123b of the data verification space 123 of the flash EEPROM 23 is the expected value by running the dedicated flash EEPROM rewriting program 231 at step S106.

When it is determined that the trailing end identification information does not match with the expected value at step S106 (NO at step S106), the CPU 21 determines that a writing error has occurred between the writing of the leading end identification information in the flash EEPROM 23 and the writing of the trailing end identification information in the flash EEPROM 23 by running the dedicated flash EEPROM rewriting program 231. Thereby, the CPU 21 determines that the communication control information (e.g., the electronic control unit name and the communication protocol), which is the data in the data space 123c between the leading end identification information and the trailing end identification information, is invalid. Then, control proceeds to step S110.

In contrast, when it is determined that the trailing end identification information matches with the expected value at step S106 (YES at step S106), the CPU 21 determines whether the leading end identification information and the trailing end identification information are identical to each other by running the dedicated flash EEPROM rewriting program 231 at step S107.

When it is determined that the leading end identification information and the trailing end identification information are not identical to each other at step S107 (NO at step S107), the CPU 21 determines that a writing error has occurred between the writing of the leading end identification information in the flash EEPROM 23 and the writing of the trailing end identification information in the flash EEPROM 23 by running the dedicated flash EEPROM rewriting program 231. Thereby, the CPU 21 determines that the communication control information (e.g., the electronic control unit name and the communication protocol), which is the data in the data space 123c between the leading end identification information and the trailing end identification information, is invalid. Then, control proceeds to step S110.

In contrast, when it is determined that the leading end identification information and the trailing end identification information are identical to each other at step S107 (YES at step S107), the CPU 21 determines that the communication control information (e.g., the electronic control unit name and the communication protocol), which is the data in the data space 123c between the leading end identification information and the trailing end identification information, is valid by running the dedicated EEPROM rewriting program 231. Thereby, the CPU 21 retrieves the communication control information (e.g., the electronic control unit name and the communication protocol), which is the data in the data space 123c, and initiates the communication with the flash EEPROM rewriting device 10 through use of the corresponding communication method according to the retrieved communication control information at step S108.

When the communication is initiated, the flash EEPROM rewriting device 10 sequentially transmits the data of the control program 232 stored in the control program storage medium of the flash EEPROM rewriting device 10 to the CPU 21. Therefore, the CPU 21 sequentially writes the received data of the control program 232 into a corresponding space of the flash EEPROM 23 to perform the rewriting process of the control program 232 by running the dedicated flash EEPROM rewriting program 231 at step S109. Specifically, according to the control program rewriting request transmitted from the flash EEPROM rewriting device 10, the corresponding block(s) of the flash EEPROM 23 is erased at once, and then the data of the control program 232 transmitted from the flash EEPROM rewriting device 10 is sequentially written into the corresponding block(s) of the flash EEPROM 23. This process is repeated from the block(s) to block(s) of the flash EEPROM 23 until all of the data of the control program 232 are rewritten in the blocks.

When the rewriting process of the control program 232 of the flash EEPROM 23 is completed, the CPU 21 jumps from the dedicated flash EEPROM rewriting program 231 to the updated control program 232, so that the operation is returned from the flash EEPROM rewriting mode to the normal control mode.

In contrast, at step S110, the CPU 21 stops the preparation of the rewriting process of the control program 232 of the flash EEPROM 23 and maintains the current state. In this way, after elapse of a predetermined time period, an error-handling process is initiated by a watchdog timer (not shown).

According to the first embodiment, the communication control information (e.g., the electronic control unit name and the communication protocol) is stored in the data verification space of the flash EEPROM 23, and the identical identification information is stored in each of the leading end location 123a and the trailing end location 123b of the data verification space 123 of the flash EEPROM 23. In this way, the validity of the communication information (e.g., the electronic control unit name and the communication protocol) stored in the flash EEPROM 23 can be more accurately determined upon satisfaction of the following conditions, i.e., (1) the leading end identification information is the expected value; (2) the trailing end identification information is the expected value; and (3) the leading end identification information and the trailing end identification information are identical to each other. Upon the determination of the validity of the communication control information (e.g., the electronic control unit name and the communication protocol), the electronic control unit 1A can reliably communicates with the flash EEPROM rewriting device 10 through the possible communication method according to the valid communication control information (e.g., the electronic control unit name and the communication protocol).

Furthermore, according to the first embodiment, even in the case where the data verification space is the part of the flash EEPROM 23, the validity of the data in the data verification space can be determined without verifying the data of the entire flash EEPROM 23.

In the above description of the operation of the first embodiment, there is described the case where determination is made with respect to the validity of the communication control information (e.g., the electronic control unit name and the communication protocol) stored in the data verification space of an unspecified size present in the flash EEPROM 23. Alternatively, the data verification space may be set as a block (hereinafter, referred to as a data verification block) of the flash EEPROM 23, and identical identification information may be stored in each of a leading end location and a trailing end location of the data verification block. In this way, the verification of the data of the entire data verification block can be performed at a high speed.

Furthermore, in the above description of the operation of the first embodiment, the single data verification space is provided in the flash EEPROM 23. Alternatively, two or more data verification spaces may be provided in the flash EEPROM 23. Furthermore, all of the blocks of the flash EEPROM 23 may be set as the data verification blocks to verify the data of the entire flash EEPROM 23.

### Second Embodiment

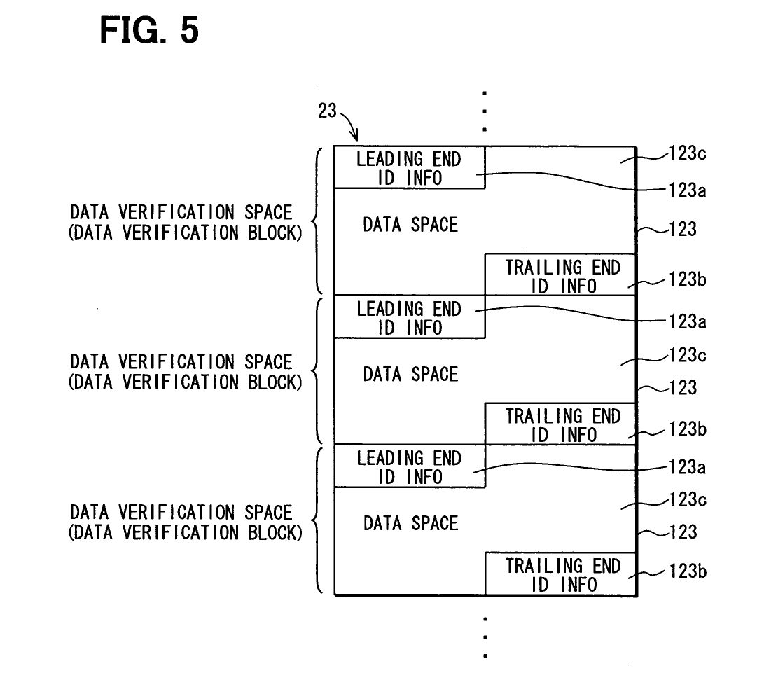

FIG. 5 is a memory map of the flash EEPROM 23, on which a data validity determining method of a flash EEPROM according to a second embodiment of the present invention is applied. In the following description, components similar to those of the first embodiment are indicated by the same numerals and will not be described further for the sake of simplicity. The data validity determining method of the flash EEPROM of the second embodiment sets each of a plurality of blocks of the entire flash EEPROM 23 as a data verification space (a data verification block) 123. Also, in each data verification block (data verification space) 123, corresponding identical identification information is stored in each of the leading end location 123a and the trailing end location 123b.

Furthermore, the corresponding identical identification information stored in each of the leading end location 123a and the trailing end location 123b of each data verification block 123 is set to be different from that of the other data verification blocks 123. For example, a data verification block specific value, such as sequential number information (e.g., a block number) of each data verification block 123, may be included in its identification information. In this way, the leading end identification information and the trailing end identification information of each data verification block are compared with a corresponding expected value, which differs from one data verification block to another data verification block. Therefore, the validity of the data in each data verification block can be more accurately determined.

The electronic control unit, to which the flash EEPROM 23 that is subject to the data validity determining method of the flash EEPROM according to the second embodiment, is constructed in a manner similar to that of the electronic control unit 1A of FIG. 1 and therefore will not be described in detail.

As discussed above, in the data validity determining method of the flash EEPROM according to the second embodiment, the data validity determining process shown in FIG. 3 is repeated for each data verification block of the flash EEPROM 23.

According to the second embodiment, in each of all of the blocks of the flash EEPROM 23, the corresponding identical identification information is stored in each of the leading end location 123a and the trailing end location 123b. Thus, it is possible to verify whether the data stored in the entire flash EEPROM 23 is correctly stored.

The embodiments of the present invention are described above. Here, it should be noted that the present invention is not limited to the above embodiments, and the embodiments may be modified without departing from the scope of the invention.

For example, according to the data validity determining method of the flash EEPROM of each of the above embodiments, the identification information is stored in each of the leading end location 123a and the trailing end location 123b of the data verification space. However, besides the leading end identification information and the trailing end identification information, one or more identification information (e.g., third identification information, fourth identification information, etc.) may be additionally stored in an intermediate location between the leading end location 123a and the trailing end location 123b in the data verification space. In this way, the data validity of the control program can be further accurately determined through use of the additional identification information.

Furthermore, it should be noted that the data validity determining method of the flash EEPROM according to each of the above embodiments is equally applicable in determination of data validity of a flash EEPROM in an ordinary electronic circuit, which includes the flash EEPROM, other than that of the vehicle.

Also, the data validity determining method of the flash EEPROM of each of the above embodiments is not limited to the data verification space of the flash EEPROM. For example, identical identification information may be stored in each of a leading end location and a trailing end location of any data verification space of any storage of any microcomputer. In this way, the data validity can be determined on any data.

Additional advantages and modifications will readily occur to those skilled in the art. The invention in its broader terms is therefore not limited to the specific details, representative apparatus, and illustrative examples shown and described.

What is claimed is:

1. A data validity determining method for a flash EEPROM, comprising:
storing data in a data verification space of the flash EEPROM in such a manner that the data is stored in a data space of the data verification space, which is interposed between a leading end location and a trailing end location in the data verification space, and each of the leading end location and the trailing end location of the data verification space stores its corresponding predetermined identification information having corresponding predetermined identification data;
verifying whether each of the predetermined identification information in the leading end location and the predetermined identification information in the trailing end location contains the corresponding predetermined identification data; and
determining that the data in the data space is valid when it is verified that each of the predetermined identification information in the leading end location and the predetermined identification information in the trailing end location contains the corresponding predetermined identification data.

2. The data validity determining method according to claim 1, wherein the data verification space is a block in the flash EEPROM.

3. The data validity determining method according to claim 2, wherein:
the block in the flash EEPROM is one of a plurality of blocks having a generally identical configuration in the flash EEPROM; and
the storing of the data in the data verification space is executed in such a manner that the corresponding predetermined identification information in the leading end location and the corresponding predetermined identification information in the trailing end location are identical to each other in each block.

4. The data validity determining method according to claim 3, wherein the identical predetermined identification information, which is stored in the leading end location and the trailing end location of each block, is different from the identical predetermined identification information of any of the rest of the plurality of blocks.

5. The data validity determining method according to claim 1, wherein the data in the data space includes an electronic control unit name and a communication protocol.

6. An electronic control system for controlling a plurality of subject devices, the electronic control system comprising a plurality of electronic control units, which are interconnected by a communication line, wherein:
each electronic control unit includes a flash EEPROM, which stores a corresponding control program for controlling a corresponding one of the plurality of subject devices;
the flash EEPROM of at least one of the plurality of electronic control units has a data verification space, which includes:
leading end identification information stored in a leading end location;
trailing end identification information stored in a trailing end location; and
intervening data that is placed between the leading end identification information and the trailing end identification information; and
each of the leading end identification information and the trailing end identification information includes its corresponding predetermined identification data.

7. The electronic control system according to claim 6, wherein the data verification space is a block in the flash EEPROM.

8. The electronic control system according to claim 6, wherein:
the block in the flash EEPROM is one of a plurality of blocks having a generally identical configuration in the flash EEPROM; and
predetermined identification information is stored as the leading end identification information of the leading end and as the trailing end identification information of the trailing end of each block.

9. The electronic control system according to claim 8, wherein the predetermined identification information, which is stored in the leading end location and the trailing end location of each block, is different from the predetermined identification information of any of the rest of the plurality of blocks.

10. The electronic control system according to claim 6, wherein the intervening data includes an electronic control unit name and a communication protocol.

11. The electronic control system according to claim 6, wherein the electronic control system is for a vehicle.

12. The electronic control system according to claim 6, further comprising a connecting means for connecting with an external flash EEPROM rewriting device, wherein each of the at least one of the plurality of electronic control units rewrites the control program thereof after satisfaction of the following conditions:
the flash EEPROM rewriting device is connected to the electronic control system through the connecting means; and
the electronic control unit determines that the intervening data thereof is valid based on the leading end identification information and the trailing end identification information.

13. The electronic control system according to claim 12, wherein the electronic control unit determines that the intervening data thereof is valid when the leading end identification information and the trailing end identification information are identical to each other.

14. The electronic control system according to claim 12, wherein the flash EEPROM of the at least one of the plurality of electronic control units further stores a flash EEPROM rewriting program for rewriting the control program.
